(19) United States
(12) Patent Application Publication
(10) Pub. No.: US 2001/0048771 A1
(43) Pub. Date: Dec. 6, 2001

(54) Image processing method and system for interpolation of resolution

(75) Inventor: Daigo Sasaki, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/863,392

(22) Filed: May 24, 2001

(30) Foreign Application Priority Data
May 25, 2000 (JP) 2000-155047

(51) Int. Cl. G06T 5/00; G06K 9/40; G06T 5/10; G06T 5/50

(52) U.S. Cl. 382/260; 382/262; 382/264; 382/269; 382/299; 382/300

(57) ABSTRACT

An image processing method is provided, which makes it possible to enlarge an input or original image in such a way as to suppress or eliminate jaggies at the contours in the image, and which is applicable to a dot-matrix type display device with a fixed resolution. In the step (a) a local area is defined in an input image. The local area includes a target pixel and neighboring pixels surrounding the target pixel. In the step (b), a filtering operation is applied to the target pixel and the neighboring pixels in the local area while all the pixels in the local area are successively assigned to the target pixel, thereby outputting a filtered image. In the step (c), the filtered image and the input image are mixed together at a specific mixing ratio, thereby forming an output image. In the step (b), the median or average value is preferably used for forming the filtered image.

### BACKGROUND OF THE INVENTION

1. Field of the Invention

The present invention relates to an image processing technique for interpolation of resolution to enlarge input or original images, more particularly, the invention relates to an image processing method and an image processing system applicable to display controllers for various information processing systems, such as Liquid-Crystal Displays (LCDs), Electroluminescent (EL) displays, and Plasma Display Panels (PDPs); and a computer program product having a computer readable medium and a computer program recorded thereon that performs the method

2. Description of the Related Art

Conventionally, image data sent from computers and graphic or video data for ordinary Televisions (TVs) according to the NTSC (National Television System Standard Committee) system or for High-Definition TVs (HDTVs) have various resolutions. The available resolutions of these data are specified by their formats.

When images with different resolutions are displayed on the screen of a Cathode-Ray Tube (CRT), quality deterioration of the displayed images can be avoided without any particular complicated process This is because a CRT is equipped with the so-called “mutit-scan” function and thus, it can display all the images on the screen according to their resolution.

Unlike this, LCDs or PDPs are unable to have a function corresponding to the “multi-scan” function of CRTs, because they have a fixed number of pixels on their screen. Therefore, if the resolution of an input image is lower than the fixed, maximum resolution of a LCD or PDP, some interpolation is necessary to enlarge the image to the whole screen.

Particularly, in recent years LCD panels with a very high resolution termed the “Ultra-Extended Graphics Array (UXGA)” for 1600×1200 pixels have been developed and have begun being manufactured. From this point of view, when an input image has a less resolution than a display device, it is important how to enlarge the input image so as to accord with the fixed, maximum resolution of the display device.

Formerly, to enlarge an input image for this purpose, a suitable interpolation process has been typically applied to the input image using a specific interpolation function on the basis of the well-known sampling theorem.

For example, with the “nearest neighbor” method, the value of a nearest neighboring pixel of a target pixel in an input image is used as the value of its interpolated pixel. With the “bilinear interpolation” method, which is a linear interpolation, a weighted average value of two or four pixels around a target pixel in an input image is used as the value of its interpolated pixel. With the “cubic convolution” method, a specific interpolation function (not shown here) is used as its approximation function to improve the interpolation accuracy compared with the nearest neighbor and bilinear interpolation methods. However, these three methods have the following disadvantages.

Specifically, the nearest neighbor method preserves the steep edges of the regions and/or objects in the input image, where the “steep edges” are the edges having abrupt density change. However, this method has a disadvantage that the image quality degrades due to jaggies formed at the boundaries or contours of the regions and/or objects.

The bilinear interpolation method suppresses the jaggies occurring in the nearest neighbor method. However, the image quality degrades like the nearest neighbor method, because the edges of the regions and/or objects in the image tend to blur due to the use of the weighted average values.

The cubic convolution method suppresses or prevents the jaggies occurring in the nearest neighbor method like the bilinear interpolation method. At the same time as this, the cubic convolution method improves the sharpness or steepness of the edges of regions and/or objects in the image compared with the bilinear interpolation method. However, the interpolation function used in this method serves basically as a low-pass filter and as a result, there is a disadvantage that the edges of the regions and/or objects in the image tend to blur if the objects include characters or letters.

As a device to suppress or prevent the jaggies at the contours and the blurs at the edges in the input image, the Japanese Non-Examined Patent Publication No. 8-171633 published in 1996 discloses an image enlargement device. The basic configuration of this device is shown in FIG. 1.

In FIG. 1, an input memory 101 stores the luminance or density value of every pixel of an input digital image and outputs the density value at a first read address specified by a controller 105.

An intermediate value detector 102 detects the maximum and minimum density values of the four input values sent from an output memory 104 and then, it outputs the two remaining values (i.e., intermediate values) thereof to an average value calculator 103.

The average value calculator 103 calculates an average value of the two intermediate values sent from the intermediate value detector 102 and then, it outputs the average value thus calculated to the output memory 104.

The output memory 104 stores the value of the first read address outputted from the input memory 101 or the average value outputted from the average value calculator 103 to a write address specified by the controller 105. When the controller 105 specifies a second read address to the output memory 104, the output memory 104 outputs the value at the specified second read address to the intermediate value detector 102.

In operation, prior to image enlargement, the luminance or density values of the whole pixels of the input image are stored in the respective addresses of the input memory 101. Then, under the control of the controller 105, the value of the target pixel of the input image stored in the memory 101 is read out from the input memory 101 and then, the value thus read out is stored in output memory 104 as the value of a corresponding one of the interpolated pixels of an enlarged image. Next, the values of the four neighboring pixels around the target pixel (which are located at the corners of a square area and the target pixel is located at the center of the area), which have been already defined, are read out from the output memory 104. Then, they are sent to the intermediate value detector 102.

In the detector 102, the maximum and minimum values of the four neighboring pixels are removed and then, the two remaining intermediate values thereof are sent to the average value calculator 103. In the calculator 103, the average value of the two remaining intermediate values is calculated and sent to the output memory 104.

In the output memory 104, the average value of the two remaining intermediate values thus sent is stored at the address of the corresponding one of the interpolated pixels of the enlarged image.

However, the image enlargement device shown in FIG. 1 has the following problems:

Although blurs for the oblique edges are improved, blurs for the horizontal and vertical edges are scarcely improved, which are approximately the same as those generated by the cubic convolution method. Also, almost no improvement is seen for thin lines having a width of one pixel. Moreover, the device configuration is not suitable to real-time processing and thus, the device is difficult to be mounted on an image processing apparatus or system.

On the other hand, the Japanese Non-Examined Patent Publication No. 7-182503 published in 1995 discloses an image processing method and device, in which low-resolution image data including characters and lines and natural pictures is well converted to high-resolution image data. In this device, each of the pixels of low-resolution image data is enlarged to (N×M) pixels, thereby converting it to high-resolution image data, where N and M are integers greater than unity.

The pixel value distribution evaluation circuit evaluates the distribution of the values of neighboring pixels around a target pixel in the low-resolution image data. The representative value decision circuit decides two representative values from the values of the neighboring pixels. The assignment circuit assigns the two representative values to the two regions formed by the separation circuit. Thus, the low-resolution image data is converted to the high-resolution image data in such a way that the characters and lines in the input image include clear edges and substantially no jaggies and at the same time, the natural pictures therein include substantially no blurs due to interpolation.

However, the device disclosed by the Publication No. 7-182503 is quite different in configuration as the invention, the reason of which will be clarified by the explanation presented below.

### SUMMARY OF THE INVENTION

Accordingly, an object of the present invention is to provide an image processing method and an image processing system that improve the quality of an enlarged image of an input or original image including characters and lines, and a computer program product that performs the method.

Another object of the present invention is to provide an image processing method and an image processing system that make it possible to enlarge an input or original image in such a way as to suppress or eliminate jaggies at the contours in the image, and a computer program product that performs the method.

Still another object of the present invention is to provide an image processing method and an image processing system that makes it possible to enlarge an input or original image in such a way as to suppress or eliminate jaggies at the contours and blurs at the edges, and a computer program product that performs the method.

A further object of the present invention is to provide an image processing method and an image processing system that are applicable to real-time processing for enlarging an input or original image, and a computer program product that performs the method.

The above objects together with others not specifically mentioned will become clear to those skilled in the art from the following description.

According to a first aspect of the present invention, an image processing method is provided. This method comprises the steps of:

(a) defining a local area in an input image;

the local area including a target pixel and neighboring pixels surrounding the target pixel;

(b) applying a filtering operation to the target pixel and the neighboring pixels in the local area while all the pixels in the local area are successively assigned to the target pixel, thereby outputting a filtered image; and

(c) mixing the filtered image and the input image together at a specific mixing ratio, thereby forming an output image.

With the method according to the first aspect of the present invention, in the step (b), the filtering operation is applied to the target pixel and the neighboring pixels in the local area defined in the step (a) while all the pixels in the local area successively assigned to the target pixel. Thus, the filtered image is outputted.

Then, in the steps (c), the filtered image and the input image are mixed together at a specific mixing ratio, thereby forming the output image.

As a results the input image can be enlarged in such a way as to suppress or eliminate the jaggies at the contours; in other words, the enlarged image of the input image has smooth contours. This means that the quality of the enlarged image is improved.

Also, since the input image is simply subjected to the filtering process in the step (b) and the mixing process in the step (c), this method is applicable to real-time processing for enlarging the input image

In a preferred embodiment of the method according to the first aspect, in the step (b) of applying the filtering operation, the pixel having a median value of density values of all the pixels in the local area is extracted, and the median value thus extracted is used for forming the filtered image.

In another preferred embodiment of the method according to the first aspect, in the step (b) of applying the filtering operation, (b-1) an average value of density values of all the pixels in the local area is calculated, (b-2) one of the pixels having a nearest density value to the average value in the local area is extracted, and (b-3) the density value thus extracted is used for forming the filtered image.

In still another preferred embodiment of the method according to the first aspect, a step of enlarging an original image at a specific enlarging ratio to form the input image is additionally provided. In this embodiment, it is preferred that the mixing ratio is adjusted according to the enlarging ratio.

According to a second aspect of the present invention, another image processing method is provided. This method comprises the steps of:

(a) defining a local area in an input image;

the local area including a target pixel and neighboring pixels surrounding the target pixel;

(b) applying a filtering operation to the target pixel and the neighboring pixels in the local area while all the pixels in the local area successively assigned to the target pixel, thereby outputting a filtered image;

the filtered image having a jaggy different in phase from a jaggy in the input image; and

(c) mixing the filtered image and the input image together at a specific mixing ratio, thereby forming an output image;

wherein the jaggy in the input image is suppressed by that in the filtered image in the step (c), resulting in the output image.

With the method according to the second aspect of the invention, the filtered image having the jaggy different in phase from the jaggy in the input image is outputted in the step (b). Then, the filtered image and the input image are mixed together at a specific mixing ratio in the step (c), thereby forming the output image. In the step (c), the jaggy in the input image is suppressed by the jaggy in the filtered image to thereby form the output image. Accordingly, there are the same advantages as those in the method according to the first aspect.

In a preferred embodiment of the method according to the second aspect, in the step (b) of applying the filtering operation, the pixel having a median value of density values of all the pixels in the local area is extracted, and the median value thus extracted is used for forming the filtered image. In another preferred embodiment of the method according to the second aspect, in the step (b) of applying the filtering operation, (b-1) an average value of density values of all the pixels in the local area is calculated, (b-2) one of the pixels having a nearest density value to the average value in the local area is extracted, and (b-3) the density value thus extracted is used for forming the filtered image.

In still another preferred embodiment of the method according to the second aspect, a step of enlarging an original image at a specific enlarging ratio to form the input image is additionally provided. In this embodiment, it is preferred that the mixing ratio is adjusted according to the enlarging ratio.

According to a third aspect of the present invention, an image processing system is provided. This system, which is used to perform the method of the first aspect, comprises:

(a) means for defining a local area in an input image;

the local area including a target pixel and neighboring pixels surrounding the target pixel;

(b) a filter for applying a filtering operation to the target pixel and the neighboring pixels in the local area while all the pixels in the local area are successively assigned to the target pixel, thereby outputting a filtered image; and

(c) an image mixer for mixing the filtered image and the input image together at a specific mixing ratio, thereby forming an output image.

With the system according to the third aspect of the invention, because of substantially the same reason as described in the method of the first aspect, there are the same advantages as those in the method of the first aspect.

In a preferred embodiment of the system according to the third aspect, in the filter, the pixel having a median value of density values of all the pixels in the local area is extracted, image.

In another preferred embodiment of the system according to the third aspect, in the filter, an average value of density values of all the pixels in the local area is calculated, one of the pixels having a nearest density value to the median value in the local area is extracted, and the density value thus extracted is used for forming the filtered image.

In still another preferred embodiment of the system according to the third aspect, an interpolation processor for enlarging an original image at a specific enlarging ratio through interpolation to form the input image is additionally provided. In this embodiment, the mixing ratio is determined according to the enlarging ratio based on interpolation performed in the interpolation processor.

According to a fourth aspect of the present invention, another image processing system is provided. This system which is used to perform the method of the second aspect, comprises:

(a) means for defining a local area in an input image;

the local areas including a target pixel and neighboring pixels surrounding the target pixel;

(b) a filter for applying a filtering operation to the target pixel and the neighboring pixels in the local area while all the pixels in the local area successively assigned to the target pixel, thereby outputting a filtered image;

the filtered image having a jaggy different in phase from a jaggy in the input image; and

(c) an image mixer for mixing the filtered image and the input image together at a specific mixing ratio, thereby forming an output image;

wherein the jaggy in the input image are suppressed by that in the filtered image in the step (c) , resulting in the output image.

With the system according to the fourth aspect of the invention, because of substantially the same reason as described in the method of the second aspect, there are the same advantages as those in the method of the second aspect.

In a preferred embodiment of the system according to the fourth aspect, in the filtering, the pixel having a median value of density values of all the pixels in the local area is extracted, and the median value thus extracted is used for forming the filtered image.

In another preferred embodiment of the system according to the fourth aspect, in the filtering, an average value of density values of all the pixels in the local area is calculated, one of the pixels having a nearest density value to the average value in the local area is extracted, and the density value thus extracted is used for forming the filtered image.

In still another preferred embodiment of the system according to the fourth aspect, a processor for enlarging an original image at a specific enlarging ratio to form the input image is additionally provided. In this embodiment, it is preferred that the mixing ratio is adjusted according to the enlarging ratio.

According to a fifth aspect of the present invention, a display controlling apparatus is provided, which comprises the image processing system according to the third or fourth aspect of the invention.

According to a sixth aspect of the present invention, a computer program product having a computer readable medium and a computer program recorded thereon is provided. The computer program is operable to generate an output image from an input image This product, which performs the method according to the first aspect, comprises:

(a) code that defines a local area in an input image;

the local area including a target pixel and neighboring pixels surrounding the target pixel;

(b) code that applies a filtering operation to the target pixel and the neighboring pixels in the local area while all the pixels in the local area are successively assigned to the target pixel, thereby outputting a filtered image; and

(c) code that mixes the filtered image and the input image together at a specific mixing ratio, thereby forming an output image.

According to a seventh aspect or the present invention, another computer program product having a computer readable medium and a computer program recorded thereon is provided. The computer program is operable to generate an output image from an input image.

This product, which performs the method according to the second aspect, comprises,

(a) code that defines a local area in an input image;

the local area including a target pixel and neighboring pixels surrounding the target pixel;

(b) code that applies a filtering operation to the target pixel and the neighboring pixels in the local area while all the pixels in the local area are successively assigned to the target pixel, thereby outputting a filtered image;

the filtered image having jaggies different in phase from jaggies in the input image; and

(c) code that mixes the filtered image and the input image together at a specific mixing ratio, thereby forming an output image;

wherein the jaggy in the input image is suppressed by that in the filtered image, resulting in the output image.

In the systems according to the third and fourth aspects, as the means for defining a local area in an input image, any hardware or software may be used it it can provide this function.

### BRIEF DESCRIPTION OF THE DRAWINGS

In order that the present invention may be readily carried into effect, it will now be described with reference to the accompanying drawings.

FIG. 1 is a functional block diagram showing the configuration of a prior-art image enlargement device.

FIG. 2 is a functional block diagram showing the configuration of an image processing system according to a first embodiment of the invention.

FIG. 3A is a schematic diagram showing the process to an input image in the image processing system according to the first embodiment of FIG. 2.

FIG. 3B is a schematic diagram showing the process of an input image by the median value extractor in the image processing system according to the first embodiment of FIG. 2.

FIG. 3C is a schematic diagram showing the process of another input image in the image processing system according to the first embodiment of FIG. 2.

FIG. 4 is a functional block diagram showing the configuration of an image processing system according to a second embodiment of the invention.

FIG. 5 is a functional block diagram showing the configuration of an image processing system according to a third embodiment of the invention.

FIG. 6 is a schematic diagram showing the process to an input image in the image processing system according to the third embodiment of FIG. 5.

FIG. 7 is a functional block diagram showing the configuration of an image processing system according to a fourth embodiment of the invention.

FIG. 8 is a schematic diagram showing the process to an input image in the image processing system according to the fourth embodiment of FIG. 7.

FIG. 9 is a schematic diagram showing the interpolation function used in the conventional nearest neighbor method.

FIG. 9B is a schematic diagram showing the interpolation function used in a conventional bilinear method.

FIG. 9C is a schematic diagram showing the interpolation function used in the image processing system according to the fourth embodiment of FIG. 7, respectively.

FIG. 10 is a functional block diagram showing the configuration of a display controlling device according to a fifth embodiment of the invention.

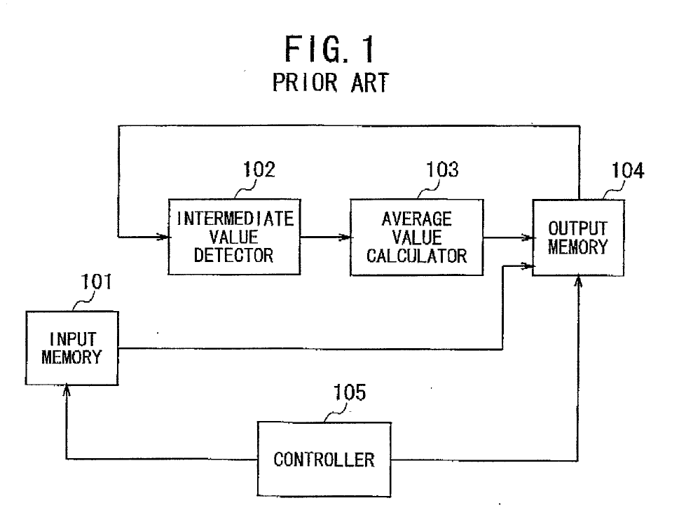

### DETAILED DESCRIPTION OF THE PREFERRED EMBODIMENTS

Preferred embodiments of the present invention will be described in detail below while referring to the drawings attached.

### FIRST EMBODIMENT

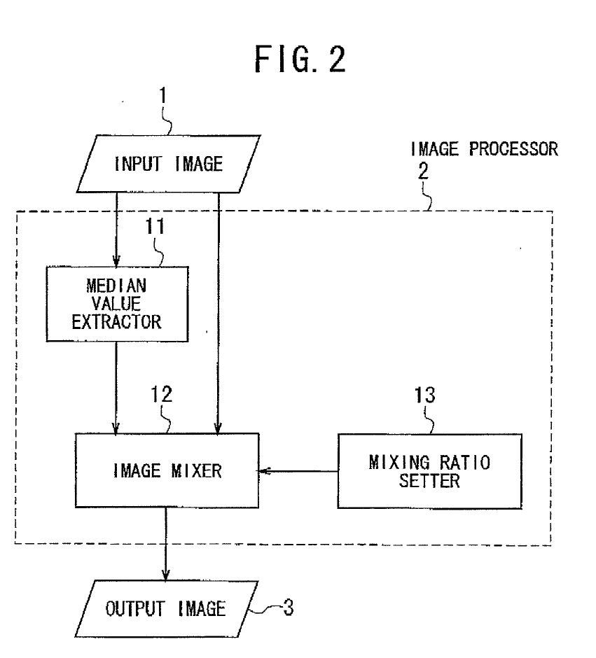

An image processing system according to a first embodiment of the invention has the configuration shown in FIG. 2, which is used to carry out an image processing method according to the first embodiment.

Specifically, as shown in FIG. 2, the image processing system of the first embodiment comprises an image processor 2 for processing an input image 1 and for outputting the processed image as an output image 3 The image processor 2 comprises a median value extractor 11, an image mixer 12, and a mixing ratio setter 13.

The median value extractor 11 provides a filtering operation that outputs the median value of the density or gray-scale levels of all the pixels (i.e., the pixel values) in a local area surrounding a target pixel of the input image 1. The median value is defined as a value in the middle of a series of the pixel values arranged in order of magnitude.

The image mixer 12 mixes the image subjected to the filtering operation in the extractor 11 (i.e., the filtered image) and the input image 1 itself at a mixing ratio specified by the mixing ratio setter 13, generating a mixed image. The mixing operation of the mixer 12 is performed by pixel by pixel in whole the input image 1. Then, the mixer 12 outputs the mixed or processed image as the output image 3.

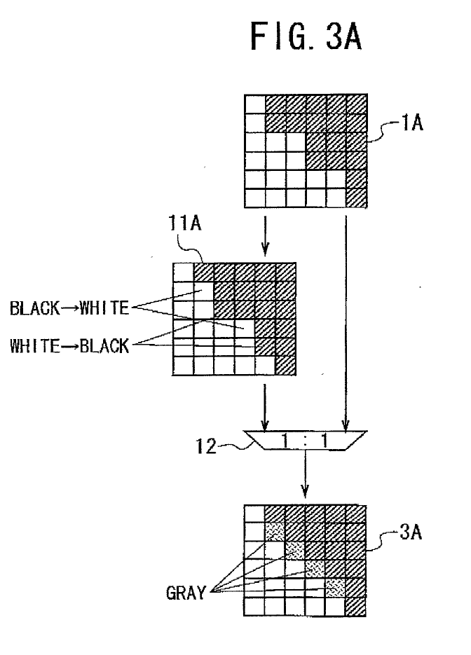

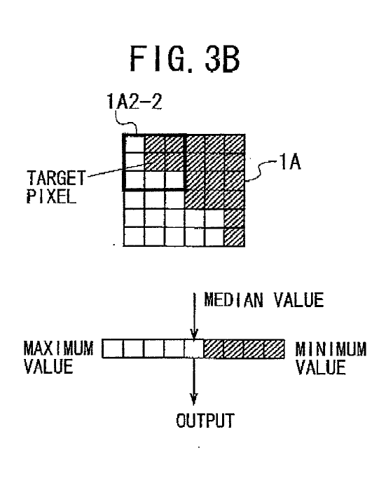

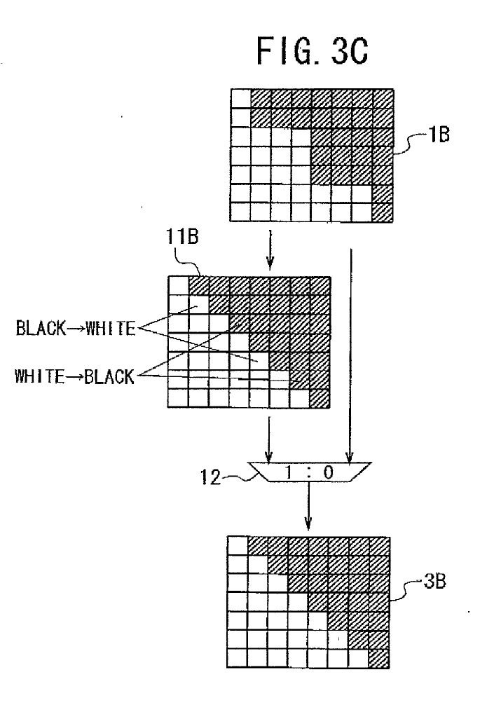

Next, the reason why the image processor 2 provides a smoothing (i.e., jaggy suppressing or eliminating) effect to the input image 1 is explained below with reference to FIGS. 3A to 3C.

FIG. 3A shows schematically the content of the filtering process of the processor 2. In FIG. 3, “1A” denotes an example of the input image 1, which includes 36 (=6×6) pixels. “11A” denotes an intermediate image produced by applying the filtering function of the median value extractor 11 to the input image 1A. “3A” denotes an example of the output image 3. “1:1” in the mixer 12 means that the input image 1A and the intermediate image 11A (ie., the output image of the extractor 11) are mixed together in the image mixer 12 at the mixing ratio of 1:1.

As seen from FIG. 3A, to make the explanation simpler, the input image 1A includes only black and white pixels here. Also, the input image 1A has a jaggy at its oblique contour or boundary of a region or an object. When the input image 1A is subjected to the filtering operation of the median value extractor 11, the intermediate image 11A is generated.

The filtering function of the median value extractor 11 is carried out in the following way.

FIG. 3B shows an example of the filtering operation of the extractor 11. In this example, the “local area” for median value extraction is a square area including nine pixels in total, where the target pixel 15 located at the center of the square area and the remaining eight pixels are located to surround the target pixel. Thus, this square local area is used for the filtering operation that extracts the median value. So, the median value extraction filter using the square local areas described here may be termed the “3×3 median filter” hereinafter.

As shown in FIG. 3B, the target pixel is defined as a second one from the left edge and from the top edge in the input image 1A. In this case, the local area is defined as a square area 1A2-2 surrounded by a thick line in the image 1A while the target pixel is “black”. The “3×3 median filter” is a filter that outputs the median value of the density values or gray-scale levels of the nine pixels (i.e., the pixel values) in the 3×3 local area 1A2-2.

Since the median value is defined as a value in the middle of a series of the nine pixel values arranged in order of magnitude of the density levels in the area 1A2-2, the median value is the density value of the white pixel, as shown in FIG. 3B. Therefore, the output of the extractor 11 for the target pixel of “black” in the local area 1A2-2 is “white”.

Next, for example, the target pixel is defined as a second one from the left edge and a third One from the top edge in the input image 1A. Then, the same filtering operation as above is carried out again. In this case, the output of the extractor 11 for the target pixel of “white” is “white”.

Similarly, the same filtering operation as above is repeated until every pixel of the input image 1A is defined as the target pixel. As a result, the intermediate image 11A shown in FIG. 3A is formed.

As seen from FIG 3A, in the intermediate image 11A, some “black” pixels at the oblique contour in the input image 1A are turned to “white” ones and at the same time, some “white” pixels at the same contour are turned to “black” ones. Such conversion between “black” and “white” does not occur in the remaining pixels in the image 11A.

Compared with the input image 1A and the intermediate image 11A, it is seen that both images 1A and 11A includes jaggies at their oblique contours; however, the state or appearance of the jaggies is different from each other. This means that the colors of the pixels at the oblique contour in the image 11A are inverted with respect to those in the image 1A. Thus, the jaggy is inverted as well between the images 11A and 1A.

Accordingly, when the input image 1A and the intermediate image 11A are mixed together by the image mixer 12 at the mixing ratio of 1:1, the inverted pixels in the images 11A and 1A are superposed together, thereby forming gray pixels in the output image 3A, as shown in FIG. 3A. In other words, since the input image 1A and the intermediate image 11A are averaged by the filtering operation of the image mixer 12, the inverted pixels in the images 11A and 1A are suppressed or eased with each other. As a result, the oblique contour in the image 1A is smoothed, i.e., the jaggy in the image 1A is suppressed.

FIG. 3C shows another example of the filtering operation of the extractor 11. In this example, a different input image 1B from the input image 1A shown in FIG. 3A is processed by the processor 2, where “11B” denotes an intermediate image outputted by the extractor 11 and “3B” denotes an output image

Compared with the intermediate images 11A and 11B of FIGS. 3A and 3C, it is seen that the image 11B includes no jaggy at its oblique contour. In other words, it is seen that the jaggy in the input image is is eliminated in the intermediate image 11B. This is due to the magnitude or size difference of the jaggy between the images 11A and 11B. Therefore, in this case, the mixing ratio is set as 1:0 and the input image 18 is not mixed with the intermediate image 11B. Thus, the intermediate image 11B itself is outputted from the processor 2 as the output image 32.

As explained as above, with the image processing system according to the first embodiment of FIG 2, the jaggy existing in the input image 1 can be eliminated or suppressed in the output image 3 by suitably setting the mixing ratio of the image mixer 13 according to the input image 1 in the mixing ratio setter 13.

Also, it is unnecessary to evaluate how the regions and/or objects are distributed in the input image 1 and to evaluate whether or not the input image 1 includes characters and/or lines are unnecessary.

In the system of the first embodiment of FIG. 2, the functions of the median value extractor 11, the image mixer 12, and the image mixing ratio setter 13 may be realized with a computer program to be prosecuted on a suitable computer system In this case, the specific codes of the program may be recorded on any information-recordable medium, such as flexible disk (FD), hard disk, magneto-optical disk (MO), CD-ROM, CD-R, magnetic tape, non-volatile memory card, and semiconductor Read-Only Memory (ROM).

### SECOND EMBODIMENT

Although the median value extractor 11 that uses the median filter is provided in the image processing system according to the first embodiment of the invention to change the phase of the jaggy in the input image in the invention is not limited to the use of the median filter. Any other filter that provides approximately the same function as the median filter may be used.

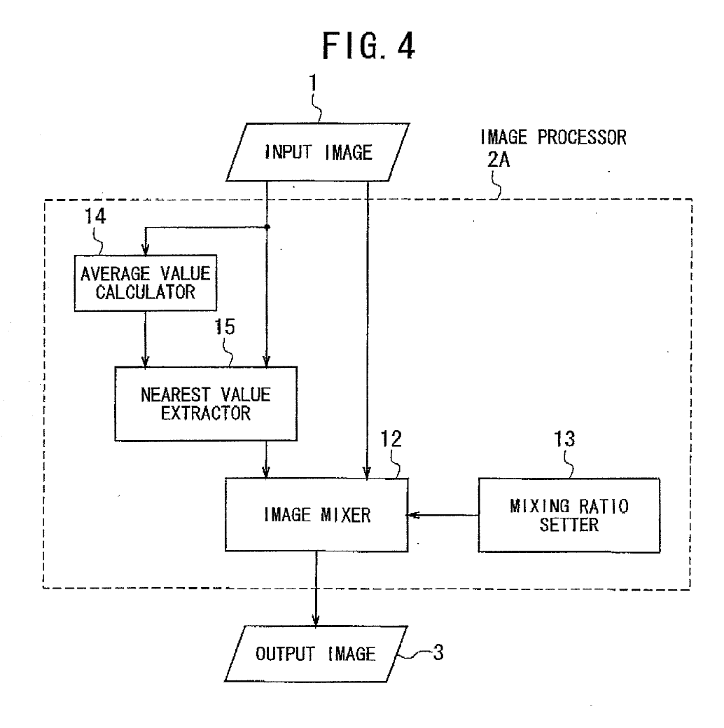

FIG. 4 shows an image processing system according to a second embodiment of the invention, which is used to carry out an image processing method according to the second embodiment.

The image processing system of the second embodiment comprises an image processor 2A for processing an input image 1 and for outputting the processed image as an output image 3. The image processor 2A comprises an average value calculator 14, a nearest value extractor 15, an image mixer 12, and a mixing ratio setter 13.

The average value calculator 14 calculates the average value of the density or gray-scale levels of all the pixels (i.e., the pixel values) in a local area surrounding a target pixel of the input image 1.

The nearest value extractor 15 receives the input image 1 and the output of the calculator 14. Then, the extractor 15 provides a filtering operation that outputs the nearest value of the density or gray-scale levels of the pixel (i.e., the nearest pixel value) in the local area of the input image 1. The nearest pixel value thus obtained in the extractor 15 is sent to the image mixer 12. The mixer 12 performs its mixing operation by pixel by pixel.

The image mixer 12 mixes the image subjected to the filtering operation in the extractor 15 and the input image 1 itself at a mixing ratio specified by the mixing ratio setter 13, generating a mixed image. Then, the mixer 12 outputs the mixed image as the output image 3.

As explained as above, with the image processing system according to the second embodiment of FIG. 4, like the system of the first embodiment, the jaggy in the input image 1 can be eliminated or suppressed without evaluating how the regions and/or objects are distributed in the input image 1 nor whether or not the input image 1 includes characters and/or lines.

As seen from the systems of the first and second embodiments, it is preferred to consider the contrast of the pixels in the input image in the filtering operation. The effect to suppress the jaggy of the systems is more effective when the input image 1 has high contrast, e.g., when the image 1 is an image created by computers, image scanners, or the like. Therefore, preferably, a means for evaluating the contrast of the input image 1 may be additionally provided. In this case, it is preferred that the image 1 is sent to the system of the first or second embodiment when the contrast of the image 1 is over a specific threshold value.

In the system of the second embodiment of FIG. 4, the functions of the average value calculator 14, the nearest value extractor 15, the image mixer 12, and the image mixing ratio setter 13 may be realized with a computer program to be prosecuted on a suitable computer In this case, the specific codes of the program may be recorded on any information-recordable medium, examples of which are listed in the first embodiment.

### THIRD EMBODIMENT

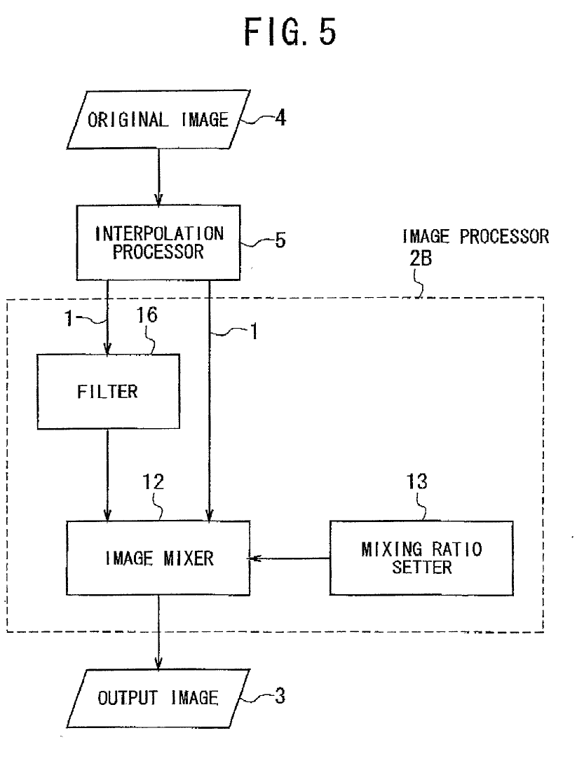

FIG. 5 shows an image processing system according to a third embodiment of the invention, which is used to carry out an image processing method according to the third embodiment.

The image processing system of the third embodiment comprises an image processor 2B for processing an input image 1 and for outputting the processed image as an output image 3 and an interpolation processor 5 for enlarging an original image 4 at a specific enlarging ratio through an interpolation process. The processor 5 is located outside the image processor 2B.

The output of the interpolation processor 5 is used as the input image for the image processor 2, which is unlike the first and second embodiments explained above.

The image processor 2B comprises a filter 16, an image mixer 12, and a mixing ratio setter 13

The filter 16 provides a filtering operation that has been explained in the first or second embodiment for the input image 1. The filter 16 may provide other filtering operation than those of the first and second embodiments if it outputs approximately the same result as shown in the first or second embodiment.

The image mixer 12 mixes the output of the filter 16 and the input image (i.e., the output of the interpolation processor 5) together at a specific mixing ratio determined by the mixing ratio setter 13. The output of the mixer 12 or processor 2 is the output image 3.

As seen from FIG. 5, the system of the third embodiment is equivalent to one obtained by adding the interpolation processor to the configuration of the system of the first or second embodiment. In other words, the system of the third embodiment has substantially the same configuration as the system of the first or second embodiment except that the original image 4 is applied to the image processor 2B as the input image after the image 4 is enlarged or interpolated.

As the enlargement process in the interpolation processor 5, any interpolation method (e.g, the nearest neighboring or bilinear method) may be used. As explained later, to utilize effectively the performance that jaggies can be eliminated or suppressed by the processor 2B, which varies dependent on the value of the enlarging ratio, the nearest neighboring method is suitable to this purpose. Needless to say, any other interpolation method may be adopted if it provides few blurs at the edges even if it generates jaggies at the contours.

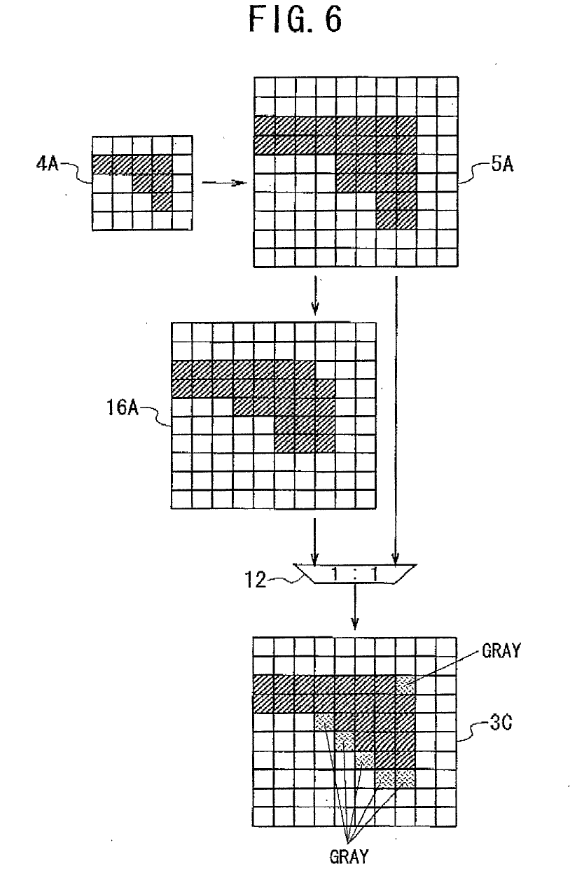

Next, the reason why the image processor 25 provides the output image 3 that preserves steep edges and suppresses contour jaggies is explained below with reference to FIG. 6.

In FIG 6, “4A” denotes an example of the original image 4, which includes 25 (=5×5) pixels. Like the first embodiment, the original image 4A includes only black and white pixels. “5A” denotes an example of the enlarged image produced by enlarging the original image 4A in the interpolation processor 5, where the enlarging ratio is 1:2. In other words, the original image 4A is doubled to form the enlarged image 5A (i.e., the input image 1) . The enlarged image 5A includes 100 (=10×10) pixels The interpolation operation of the processor 5 for enlargement is carried out using the nearest neighboring method here.

“16A” denotes an example of the filtered image produced by filtering the enlarged image 5A (i.e., the input image 1) The image 16A is the output image of the filter 16 obtained by using the “3 ×3 median filter”, which has been already referred to in the first embodiment.

The enlarged image 5A, which is the input image 1 to the image processor 2B, and the filtered image 16A (i.e., the output image of the filter 16) are mixed together in the image mixer 12 at the mixing ratio of 1:1. As a result, some of the pixels in the output image 3C are turned from black or white to gray near the edges or contour.

As seen from FIG. 6, the enlarged image 5A includes steep edges; however it includes conspicuous oblique jaggy. Compared with the image 5A with the output image 3C, it is seen that the conspicuous oblique jaggy in the image 5A disappears in the image 3C. This means that the oblique jaggy in the image 5A is eliminated by mixing the images 5A and 16A with the image mixer 12 at the mixing ratio of 1:1. Moreover, the steep edges at the horizontal and vertical contours in the image 5A are kept substantially unchanged in the output image 3C, which has been difficult to be realized by the conventional interpolation methods.

With the image processing system according to the third embodiment of FIG. 5, as explained above, there is an advantage that the output image 3 includes almost no jaggy and steep edges substantially unchanged.

In the system of the third embodiment, the enlarging ratio of the original image 4 may be set optionally as necessary. However, it is preferred that the enlargement ratio of the original image 4A is equal to an integer. In particular, it is most preferred that the enlargement ratio of the original image 4A is equal to two, as shown in FIG. 6. This is because the elimination of the jaggy by the processor 2B is performed most effectively in this case.

The system of the third embodiment is suitable when the original image 4 is an image including conspicuous jaggies. Especially, it is more suitable to artificial digital images for personal computers (PCs) including texts and/or drawings. Needless to say, it may be applicable to any image including natural pictures.

In the system of the third embodiment of FIG. 5, the functions of the interpolation processor 5, the filter 16, the image mixer 12, and the image mixing ratio setter 13 may be realized with a computer program to be prosecuted on a suitable computer. In this case, the specific codes of the program may be recorded on any information-recordable medium, examples of which are listed in the first embodiment.

### FOURTH EMBODIMENT

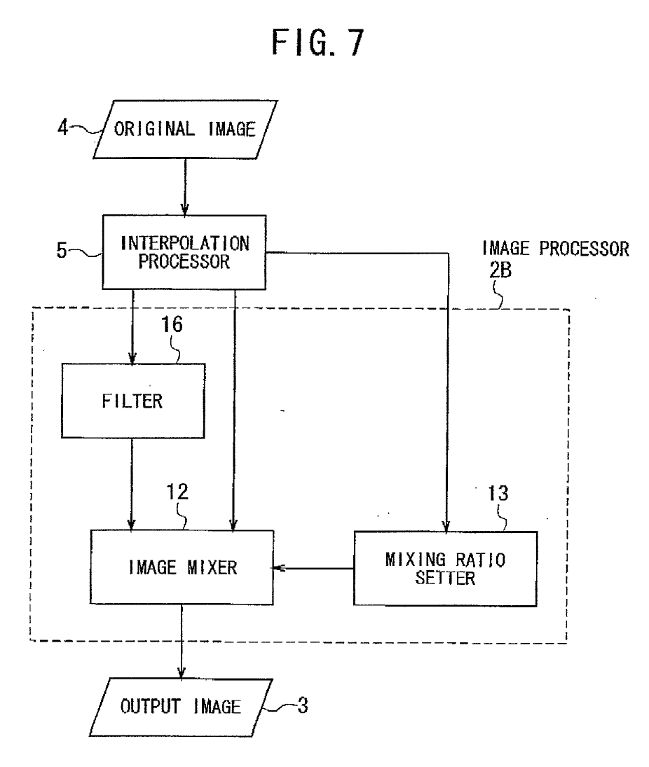

FIG. 7 shows an image processing system according to a fourth embodiment of the invention, which is used to carry out an image processing method according to the fourth embodiment. This system has the same configuration as the system of the third embodiment of FIG. 5 except that the mixing ratio of the mixing ratio setter 13 is determined on the basis of the information obtained in the interpolation processor 5.

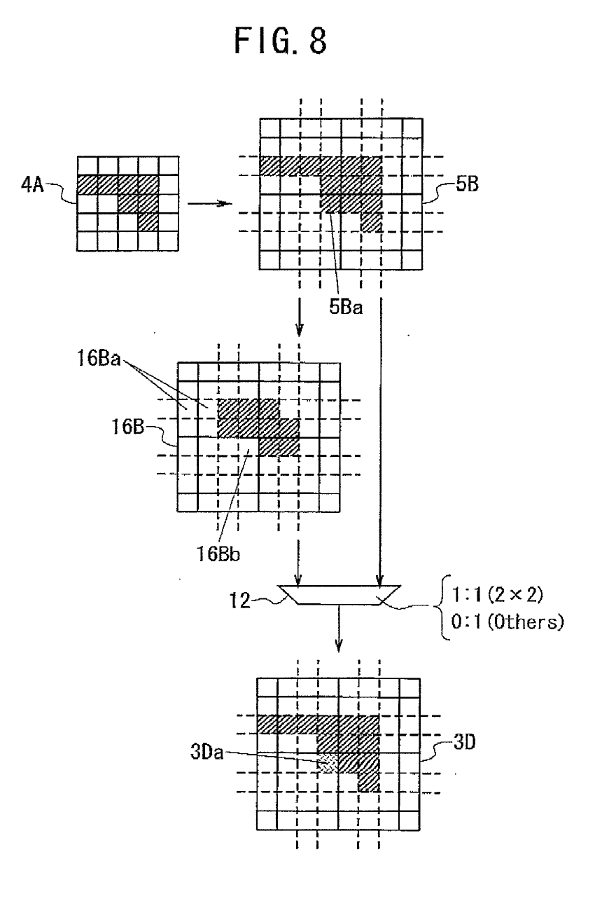

FIG. 8 shows the process of the system of the fourth embodiment, in which an example of the original image 4 is enlarged to form an enlarged image 5B at the enlarging ratio of 1.6 by the interpolation processor 5 using the nearest neighbor method. As seen from FIG. 8, since the enlarging ratio is not equal to an integer, each of the pixels of the original image 4A can be assigned to 2 ×2 (=4) pixels, 1×2 (=2) pixels, 2×1 (=2) pixels, or 1×1 (=1) pixels of the enlarged image 5B. Generally, there are four assignment ways of each pixel of the original image 4A to the pixel or pixels of the enlarged image 5B when the enlarging ratio is equal to or less than two.

It is seen from FIG 8 that the pixels of the original image 4A assigned to the 2×2 (=4) pixels of the enlarged image 5B include a jaggy in their neighborhood. Thus, it is sufficient that the operation to eliminate or suppress jaggies is applied to the pixels of the image 4A assigned to the 2×2 (=4) pixels of the image 5B.

A filtered image 16B in FIG. 8 is produced by the filtering operation of the filter 16 to the enlarged image 5B, where the “3 ×3 median filter” is used. Am seen from comparison between the enlarged images 16A and 16B, the line with a width of one pixel, which is formed by the pixels 18Ba, disappears in the image 16B. Thus, to overcome this problem, the assignment information is sent from the interpolation processor 5 to the mixing ratio setter 13, The setter 13 changes or adjusts the value of the mixing ratio according to the assignment information thus sent.

For example, when the “2×2 assignment” is made, i.e., the pixel of the original image 4A is assigned to the 2×2 (=4) pixels of the enlarged image 5B, the mixing ratio is set as 1:1. This means that the filtered image 16B and the enlarged image 53 (i.e., the input image 1) are mixed or added together at 1:1 (e.g., 5: 5), thereby forming an example 3D of the output image, as shown in FIG. 8. in this case, the pixel 3Da of the output image 3D has the same density value as the pixel 5Ba of the enlarged image 5B.

Unlike this, when any other assignment then the “2×2 assignment” is made, ie., the pixel of the original image 4A is assigned to the 1×2 (=2) pixels, 2×1 (=2) pixels, or 1×1 (=1) pixel of the enlarged image 5B, the mixing ratio is set as 0:1 (e.g., 0:10) This means that only the enlarged image 5B (i.e., the input image 1) is outputted from the image mixer 12 as the output image 3, thereby forming the image 3D shown in FIG. 8. In this case, the pixel 3Da of the output image 3D has a density value equal to half the density values of the pixel 16Bb of the filtered image 16B (i.e., gray).

As seen from the output image 3D in FIG. 8, the jaggy at the oblique contour is eased or eliminated while the edges are kept steep.

As described above, with the image processing system according to the fourth embodiment of FIG. 7, the interpolation processor 5 sands the assignment information to the mixing ratio setter 13 and then, the setter 13 changes or adjusts the value of the mixing ratio according to the information thus sent. Therefore, the enlarged image 52 having less quality degradation can be produced with the interpolation processor 5 not only when the enlargement ratio of the original image 4A is equal to an integer but also it is unequal to an integer.

The nearest neighbor method is used in the interpolation processor 5 as the interpolation function here, However, any other interpolation method may be used for this purpose if it provides suitable enlargement of the original image 4A.

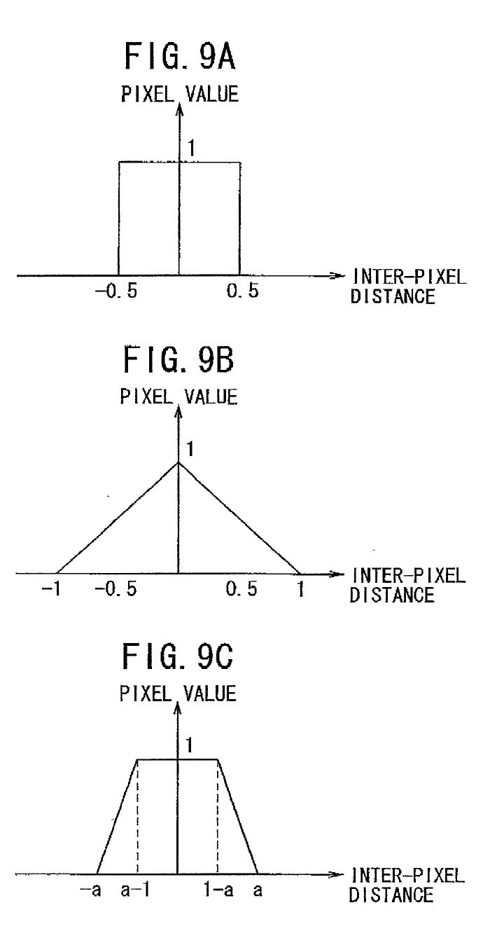

For example, an interpolation function obtained by is combining the nearest neighbor method with the bilinear method may be used. When the inter-pixel distance of the original image 4A is defined as 1, the interpolation function used in the nearest neighbor method is given by the line shown in FIG. 9A. The interpolation function used in the bilinear method is given by the line shown in FIG. 9B.

As explained earlier in this specification, the nearest neighbor method preserves the steep edges of the regions and/or objects in an image while the image quality degrades due to jaggies existing at the contours of the regions and/or objects. The bilinear interpolation method suppresses the jaggies occurring in the nearest neighbor method while the image quality degrades because the edges of the regions and/or objects in the image tend to blur. Thus, each of the interpolation functions of FIGS. 9A and 9B has its merits and demerits. To overcome this trade-off simply, the inventor created the interpolation function, as shown in FIG. 9C. This function corresponds to the combination of the functions of FIGS. 9A and 9B.

In the function of FIG. 9C, a is a constant greater than 0.5 and less than 1 (i.e., 0.5<a<1). Optional value change of the constant a causes the output image 3. When the value of a is set as small within the range of 0.5<a<1, the edges of the image 3 will be sharp. On the contrary, when the value of a is set as large within the range of 0.5<a<1, the total balance of the image 3 will be good.

It is preferred that a suitable one of the interpolation functions is selected according to the type of the original image 4 and/or the enlarging ratio of the interpolation processor 5. Needless to say, the cubic convolution method may be used for this purpose.

With the system according to the fourth embodiment of FIG. 7, there is an advantage that the output image 3 includes no jaggies and steep edges even if the original image 4 is enlarged at an optional enlarging ratio (in particular, the ratio is unequal to an integer) in the interpolation processor 5.

In the image processing system of the fourth embodiment of FIG. 7, the functions of the interpolation processor 5, the filter 16, the image mixer 12, and the image mixing ratio setter 13 may be realized with a computer program to be prosecuted on a suitable computer. In this case, the specific codes of the program may be recorded on any information-recordable medium, examples of which are listed in the first embodiment.

### FIFTH EMBODIMENT

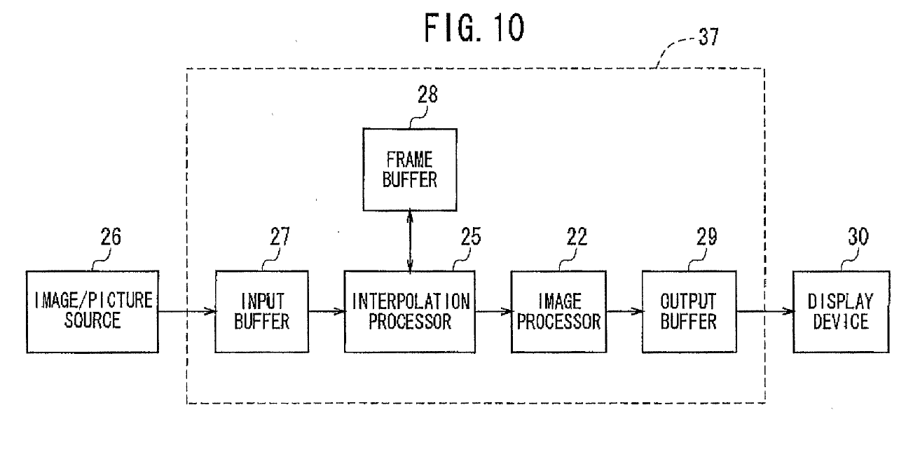

FIG. 10 shows the configuration of a display controlling apparatus 37 according to a fifth embodiment of the invention, which comprises an input buffer 27, a frame buffer 28, and an output buffer 29 along with an interpolation processor 25 and an image processor 22. An image or picture is inputted into the apparatus 37 from an image/picture source 26. The output of the apparatus 37 is sent to a display device 30. The device 30 has a raster scanning function and therefore, the image or picture image/picture sent from the source 26 is prepared for the same function.

As the interpolation processor 25, one of the interpolation processors 5 used in the first to fourth embodiments may be used. As the image processor 22, one of the image processors 2 used in the first to fourth embodiments may be used.

An original image and/or picture 4 sent from the source 26 is temporarily stored in the input buffer 27 for buffering. The original image 4 in the buffer 27 is then sent to the interpolation processor 25, in which the image 4 is subjected to a specific interpolation operation, thereby enlarging the image 4. The output of the processor 25 (i.e., the enlarged image) is then sent to the image processor 22, in which the jaggies in the enlarged image are eliminated. The output of the processor 22 (i.e., the filtered, enlarged image) is temporarily stored in the output buffer 29 and then, it is sent to the display device 30. Thus, the original image 4 is displayed on the screen of the device 30 at an enlarged or interpolated resolution.

As the display device 30, a CRT, LCD, PDP, or EL display may be used. However, it is preferred that the device 30 is of he type having a fixed resolution, such as a LCD, PDP, and EL display, because they are of the dot-matrix type where the pixels are arranged in a matrix array and they have a fixed resolution.

With the display controlling apparatus 37 according to the fifth embodiment of FIG. 10, the output image 3 including no jaggies and steep edges can be displayed on the screen of the display device 30.

### VARIATIONS

Needless to say, the invention is not limited to the above-described first to third embodiments For example, the invention may be applied to a system comprising a plurality of apparatuses or devices, or to a single apparatus or device.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. An image processing method comprising the steps of:
(a) defining a local area in an input image;
the local area including a target pixel and neighboring pixels surrounding the target pixel;
(b) applying a filtering operation to the target pixel and the neighboring pixels in the local area while all the pixels in the local area are successively assigned to the target pixel, thereby outputting a filtered image; and
(c) mixing the filtered image and the input image together at a specific mixing ratio, thereby forming an output image.

2. The method according to claim 1, wherein in the step (b) of applying the filtering operation, the pixel having a median value of density values of all the pixels in the local area is extracted, and the median value thus extracted is used for forming the filtered image.

3. The method according to claim 1, wherein in the step (b) of applying the filtering operation,
(b-1) an average value of density values of all the pixels in the local area is calculated;
(b-2) one of the pixels having a nearest density value to the average value in the local area is extracted; and
(b-3) the density value thus extracted is used for forming the filtered image.

4. The method according to claim 1, further comprising a step of enlarging an original image at a specific enlarging ratio to form the input image.

5. The method according to claim 4, wherein the mixing ratio is determined according to the enlarging ratio.

6. An image processing method comprising the steps of:
(a) defining a local area in an input image;
the local area including a target pixel and neighboring pixels surrounding the target pixel;
(b) applying a filtering operation to the target pixel and the neighboring pixels in the local area while all the pixels in the local area are successively assigned to the target pixel, thereby outputting a filtered image;
the filtered image having a jaggy different in phase from a jaggy in the input image; and
(c) mixing the filtered image and the input image together at a specific mixing ratio, thereby forming an output image;
wherein the jaggy in the input image is suppressed by that in the filtered image in the step (c), resulting in the output image.

7. The method according to claim 6, wherein in the step (b) of applying the filtering operation, the pixel having a median value of density values of all the pixels in the local area is extracted, and the median value thus extracted is used for forming the filtered image.

8. The method according to claim 6, wherein in the step (b) of applying the filtering operation;
(b-1) an average value of density values of all the pixels in the local area is calculated;
(b-2) one of the pixels having a nearest density value to the average value in the local area is extracted; and
(b-3) the density value thus extracted is used for forming the filtered image.

9. The method according to claim 6, further comprising a step of enlarging an original image at a specific enlarging ratio to form the input image;

10. The method according to claim 9, wherein the mixing ratio is adjusted according to the enlarging ratio.

11. An image processing system comprising:
(a) means for defining a local area in an input image;
the local area including a target pixel and neighboring pixels surrounding the target pixel;
(b) a filter for applying a filtering operation to the target pixel and the neighboring pixels in the local area while all the pixels in the local area are successively assigned to the target pixel, thereby outputting a filtered image; and
(c) an image mixer for mixing the filtered image and the input image together at a specific mixing ratio, thereby forming an output image.

12. The system according to claim 11, wherein in the filter, the pixel having a median value of density values of all the pixels in the local area is extracted, and the median value thus extracted is used for forming the filtered image.

13. The system according to claim 11, wherein in the filter, an average value of density values of all the pixels in the local area is calculated, one of the pixels having a nearest density value to the median value in the local area is extracted, and the density value thus extracted is used for forming the filtered image.

14. The system according to claim 11, further comprising an interpolation processor for enlarging an original image at a specific enlarging ratio through interpolation to form the input image.

15. The system according to claim 14, wherein the mixing ratio is determined according to the enlarging ratio based on interpolation performed in the interpolation processor.

16. An image processing system comprising:
(a) means for defining a local area in an input image;
the local area including a target pixel and neighboring pixels surrounding the target pixel;
(b) a filter for applying a filtering operation to the target pixel and the neighboring pixels in the local area while all the pixels in the local area are successively assigned to the target pixel, thereby outputting a filtered image;
the filtered image having different a jaggy different in phase from a jaggy in the input image; and
(c) an image mixer for mixing the filtered image and the input image together at a specific mixing ratio, thereby forming an output image;
wherein the jaggy in the input image are suppressed by that in the filtered image in the step (c), resulting in the output image.

17. The system according to claim 16, wherein in the filter, the pixel having a median value of density values of all the pixels in the local area is extracted; and the median value thus extracted is used for forming the filtered image.

18. The system according to claim 16, wherein in the filter, an average value of density values of all the pixels in the local area is calculated; one of the pixels having a nearest density value to the median value in the local area is extracted; and the density value thus extracted is used for forming the filtered image.

19. The system according to claim 16, further comprising a processor for enlarging an original image at a specific enlarging ratio to form the input image.

20. The system according to claim 19, wherein the mixing ratio is adjusted according to the enlarging ratio.

21. A display controlling apparatus comprising the image processing system according to claim 11.

22. A display controlling apparatus comprising the image processing system according to claim 16.

23. A computer program product having a computer readable medium and a computer program recorded thereon, the computer program being operable to generate an output image from an input image;
the product comprising:
(a) code that defines a local area in an input image;
the local area including a target pixel and neighboring pixels surrounding the target pixel;
(b) code that applies a filtering operation to the target pixel and the neighboring pixels in the local area while all the pixels in the local area are successively assigned to the target pixel, thereby outputting a filtered image; and
(c) code that mixes the filtered image and the input image together at a specific mixing ratio, thereby forming an output image.

24. The product according to claim 23, wherein in the code (b) that applies the filtering operation, the pixel having a median value of density values of all the pixels in the local area is extracted, and the median value thus extracted is used for forming the filtered image.

25. The product according to claim 23, wherein in the code (b) that applies the filtering operation, an average value of density values of all the pixels in the local area is calculated; one of the pixels having a nearest density value to the median value in the local area is extracted; and the density value thus extracted is used for forming the filtered image.

26. The product according to claim 23, further comprising code that enlarges an original image at a specific enlarging ratio to form the input image.

27. The product according to claim 26, wherein the mixing ratio is determined according to the enlarging ratio.

28. A computer program product having a computer readable medium and a computer program recorded thereon, the computer program being operable to generate an output image from an input image;
the product comprising:
(a) code that defines a local area in an input image;
the local area including a target pixel and neighboring pixels surrounding the target pixel;
(b) code that applies a filtering operation to the target pixel and the neighboring pixels in the local area while all the pixels in the local area are successively assigned to the target pixel, thereby outputting a filtered image;
the filtered image having a jaggy different in phase from a jaggy in the input image; and
(c) code that mixes the filtered image and the input image together at a specific mixing ratio, thereby forming an output image;
wherein the jaggy in the input image are suppressed by that in the filtered image, resulting in the output image.
